(19) United States
(12) Patent Application Publication
(10) Pub. No.: US 2010/0046317 A1
(43) Pub. Date: Feb. 25, 2010

(54) WORM EXTRUDER COMPRISING A COOLING DEVICE IN THE FEED ZONE

(75) Inventor: Otto Grunitz, Nurnberg (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Sumitomo(SHI) Demag Plastics Machinery GmbH, Schwaig (DE)

(21) Appl. No.: 12/306,834

(22) PCT Filed: Jun. 11, 2007
(86) PCT No.: PCT/EP07/55704

§ 371 Date: Aug. 17, 2009

(30) Foreign Application Priority Data
Jun. 27, 2006 (DE) 10 2006 029 358.4

(51) Int. Cl. A21C 1/06

(52) U.S. Cl. 366/76.1

(57) ABSTRACT

A worm extruder and/or an extruder for processing plastic materials and mixtures of plastic materials includes a worm cylinder and a worm shaft which is drivable for rotation therein, wherein an end region of the worm cylinder comprises an inlet opening for feeding plastic material or mixtures of several plastic materials and/or additives in the form of a bulk material via a feed throat. At least one cooling device is provided in a section of the worm cylinder adjoining the inlet opening. An active heat barrier is provided in the region of the feed throat and includes electrically controllable means for heat dissipation. This increases the efficiency of the cooling process, reduces the operating costs and increases the operational reliability of the worm extruder.

The present invention relates to a worm extruder and/or an extruder for processing plastic materials and mixtures of plastic materials according to the preamble of claim 1.

It is known from prior art that worm extruders of this type comprise a worm cylinder with a worm shaft or a worm installed therein that is drivable for rotation. The worm cylinder comprises an inlet opening in an end region for feeding plastic material or mixtures of several plastic materials and/or additives, which are in the form of a bulk material, such as natural fibers, mineral or glass fibers and pigments, via a feed throat.

Furthermore, it is generally known from prior art that in order to be used as an extruder or in an injection molding machine for processing thermoplastic materials, worm extruders are divided into three zones along the length of an extruder worm arranged therein; a feed zone receives a bulk material which is fed in via the inlet opening so as to be compressed and heated up while being conveyed to a transformation zone. In the transformation zone, the pre-compressed and pre-heated material is degassed and subject to further, defined heating which causes a large part of the material to be plasticized and homogenized. Finally, the material enters a discharge, in other words pumping, in other words metering zone where the incoming material is homogenized and conveyed to a downstream tool.

In the basic design outlined above, so-called heating strips are arranged on the outside of the worm cylinder to ensure a continuous and defined heating of the conveyed material. In this process, it can generally occur that heat, which was absorbed by other regions of the worm cylinder, in particular as a result of the heating process by means of the (usually) electrically operated heating strips, flows into the region of the inlet opening of a plastic-material worm extruder in an uncontrolled manner. An additional amount of heat is generated when the supplied bulk material is conveyed and pre-compressed. Each of these heating effects may lead to considerable problems during the processing of the plastic material.

Therefore it is known from DE 35 04 773 A1, for example, to not only heat an extruder but to cool it as well. To this end, cooling devices are provided in a section adjoining the inlet opening. The cooling device comprises cooling ducts for guiding a fluid cooling medium such as water. In this embodiment, the worm cylinder is designed as one piece along its entire length. In the region of the cooling device, the worm cylinder has an outer surface whose outer diameter is smaller than along the remaining length of the worm cylinder. Helically extending cooling ducts are cut into the outer surface. This outer surface is enclosed by a sleeve which covers the cooling ducts, is provided with bores for feeding and discharging a cooling agent and is welded to the worm cylinder.

According to the teachings of DE 35 04 773 A1, at least one radially extending, so-called heat-conduction interrupting groove, in other words a thermal separation groove, is provided which reduces a heat-conducting cross-section of the worm cylinder in such a way that an additional reduction of a heat conduction is achieved in the direction of the axis. In particular, at least one thermal separation groove is in each case provided in front of and behind the cooling device in order to reduce the axial flow of heat from the heated regions of the worm cylinder into the cooling device and from the cooling device into the region of the inlet opening.

DE 32 27 443 A1 further teaches to produce a region surrounding the inlet opening in such a way as to form a separate component to be connected to the remaining worm cylinder, wherein cooling ducts are provided between inlet opening and flange region towards the remaining worm cylinder, and wherein this component is now separate and heat-insulated in a manner which is not described any further.

DE 33 11 199 A1 discloses another cooling device in which a double-wall sleeve is again provided with cooling ducts for a liquid cooling agent. To this end, the worm cylinder is not composed of multiple parts but sections thereof are covered in the manner of a double-wall sleeve. The flow duct for a cooling fluid is formed by a profiled plastic strip having a varying shape and contact surface between the cylinder walls of the double-wall sleeve.

According to a solution disclosed in DE 35 18 997 A1, intermediate rings are provided which define an annular duct when assembled, and which are detachably connected to the worm cylinder in such a way as to form a unit comprising cooling ducts in the form of deflecting elements so that worn-out cylinder elements can be replaced, thus resulting in a reusable cooling system.

A disadvantage of this known solution is that the effort of producing the cooling unit is in each case relatively high. Likewise, when such cooling units are operated for a longer period of time, this may impair the overall efficiency thereof. Thus, complex installations for the cooling circuit and a cooling medium processing unit are required in most cases which need to be operated continuously. Such installations are sufficiently known to those skilled in the art because cooling is usually performed using large amounts of water in order to maintain a temperature of 40° C. to 80° C. in the region of the inlet opening. An appropriate corrosion protection for the water-guiding parts, sealing means and a splash-guard for the electric devices in the region of the entire worm extruder are expensive and require a lot of energy during operation.

WO 2006/073107 A1 discloses a worm extruder with a worm cylinder in which a worm shaft is arranged that is drivable for rotation. An end region of the worm cylinder comprises an inlet opening for feeding plastic material and/or additives in the form of a bulk material via a feed throat. A cooling device comprising thermoelectric cooling elements is provided in a section of the worm extruder adjoining the inlet opening.

DD 286 326 A5 describes an extruder which is cooled via cooling ribs in a section adjoining the feed throat. Peltier elements adjoining the inlet opening are provided in the region of the feed throat.

A heat flow from the heating devices in the direction of the feed throat, which causes the supplied material to heat up, has turned out to be problematic in this respect.

It is the object of the present invention to improve a worm extruder of the mentioned type in such a way that a cooling efficiency is increased while reducing the operating costs and increasing the operational reliability.

This object is achieved by the features of the independent claims. Advantageous embodiments are set out in the respective subclaims.

In terms of design, a worm extruder comprising a worm cylinder and a worm shaft which is drivable for rotation therein, wherein the worm cylinder comprises an inlet opening for feeding plastic material or mixtures of several plastic materials and/or additives in the form of a bulk material via a feed throat, and wherein at least one cooling device is provided in a section of the worm cylinder adjoining the inlet opening, is characterized in that an active heat barrier is provided in the region of the feed throat, the heat barrier comprising electrically controllable means for heat dissipation. Thus the invention takes advantage of the fact that plasticizing units, which are equipped with a cooling zone adjoining the inlet opening when seen in a conveyance direction of a conveyed material, are not able to completely prevent a supplied granulate from clumping together due to an at least partial melting when entering the plasticizing cylinder. A continuous discharge or flow of granulate at a given granulate grain size is of vital importance to ensure a trouble-free operation of a worm extruder for processing thermoplastic polymers. The quality of an injection molded product largely depends on whether constant material flow parameters are provided at an outlet of the injection molding machine. In order to achieve this, a continuous transport of the conveyed material already in the region of the feed throat is an important factor which has so far been underestimated. An active heat barrier in the region of the feed throat effectively reduces self heating, which is for instance due to friction occurring during the feed of material and the subsequent pre-compressing transport, as well as an otherwise uncontrolled flow of heat from adjacent regions of the worm cylinder. Therefore, in a worm extruder according to the invention, a temperature is already maintained in the region of the feed throat by cooling during operation so that the granulate is substantially prevented from clumping together due to partial melting.

In accordance with the invention, the heat barrier comprises a heat insulation. This insulation prevents a heat flow, which is in particular generated by the heating strips, from heating up the material in the region of the feed throat. The heat insulation is in the shape of a sleeve so as to provide a radially closed screening. In another advantageous embodiment of the invention, it has turned out to be advantageous if the heat insulation is cylindrical and has on its inside a layer of good heat conductivity. This heat-conducting layer, which may for instance consist of sheet copper or evacuated stainless steel etc., results in an even distribution of the cooling efficiency and a heat dissipation from an interior of the feed throat.

In a preferred embodiment of the invention, it is particularly advantageous for the heat barrier to comprise at least one Peltier element. Peltier elements are thermoelectric components which require only a small amount of space and are hereinafter used as heat pumps in order to replace conventional compressor and absorber cooling systems. A Peltier element is a semiconductor component which generates a temperature difference between two (outer) surfaces that is proportional to a current flow. The temperature difference that is achievable by means of a Peltier element is easily controllable by the flow of current through the Peltier element. The efficiency of a Peltier element amounts to approx. 33%, wherein these elements are applicable up to temperatures of approx. 200° C. Peltier elements are available with a power of up to 240 W. A resulting temperature difference of a Peltier element is ΔT≈60 K. Peltier elements may be arranged in various configurations, in particular in cascaded series and/or parallel connections, as will be described below with reference to illustrations of embodiments by means of the drawing. With respect to a maximum ambient temperature of approx. 200° C., a cascade connection of n Peltier elements may therefore generate temperature differences of ΔT≈n*60 K.

In a particularly preferred embodiment of the invention, an active heat barrier is provided in a thermal separation groove. This active heat barrier comprises electrically controllable means for heat dissipation and in particular at least one Peltier element. As the heat barrier, which is arranged in the thermal separation groove, has a side facing a heat flow Q when used in a worm cylinder, it is further preferred to arrange a heat insulation on this side. However, an active heat barrier arranged in the thermal separation groove preferably comprises a heat insulation on each of its two longitudinal sides.

Furthermore, it is preferred that cooling sheets, cooling bodies or similar devices for improving at least a convective heat transmission and, if necessary, a heat dissipation are arranged on a free, outwardly oriented surface of the active heat barrier.

Further features and advantages of the invention will hereinafter be described in the description of embodiments by means of the illustrations in the drawing in which

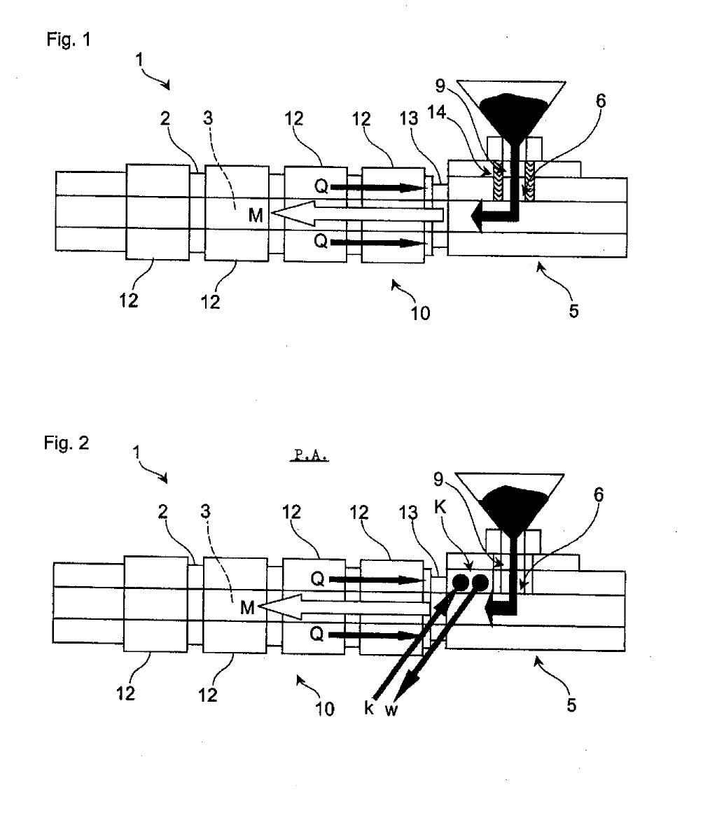

FIG. 1 shows a schematic sectional illustration of a basic design of a worm extruder comprising an active heat barrier according to a first embodiment, wherein heat flows are indicated in the Figure;

FIG. 2 shows a schematic sectional illustration similar to the illustration of FIG. 1 of a basic design of a worm extruder comprising a prior-art cooling device;

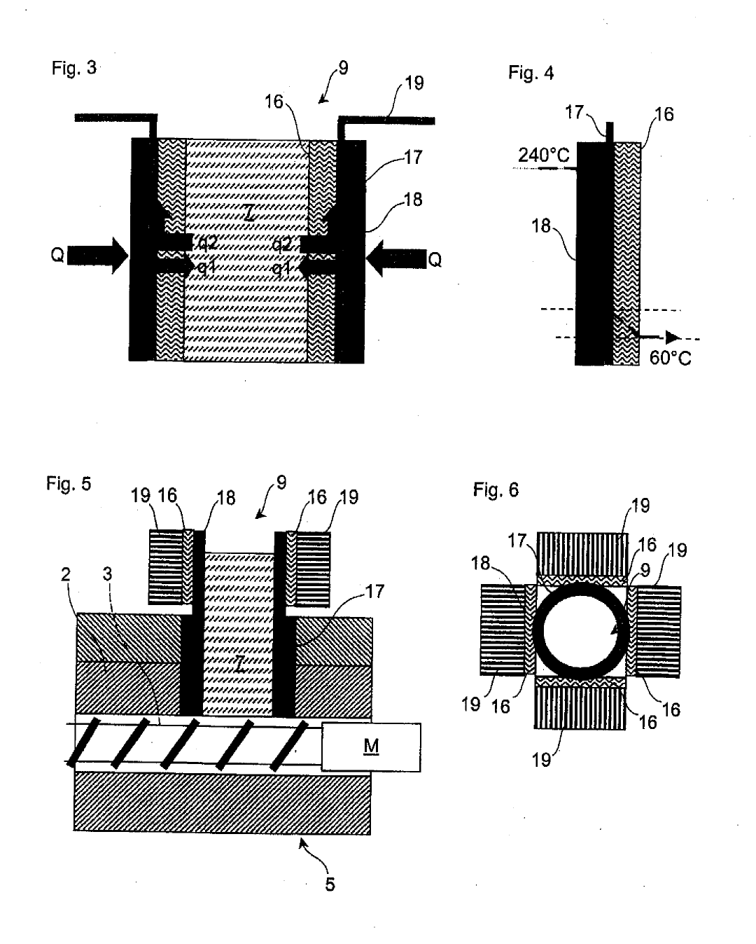

FIG. 3 shows an outlined longitudinal section through an embodiment of a feed throat with an active heat barrier and a layer of good heat conductivity;

FIG. 4 shows an outlined section of the active heat barrier according to FIG. 3 in conjunction with a temperature development;

FIG. 5 shows an outlined longitudinal section through another embodiment of a feed throat of a plasticizing unit comprising an active heat barrier, a heat insulation and a layer of good heat conductivity;

FIG. 6 shows a plan view of the feed throat in the embodiment according to FIG. 5;

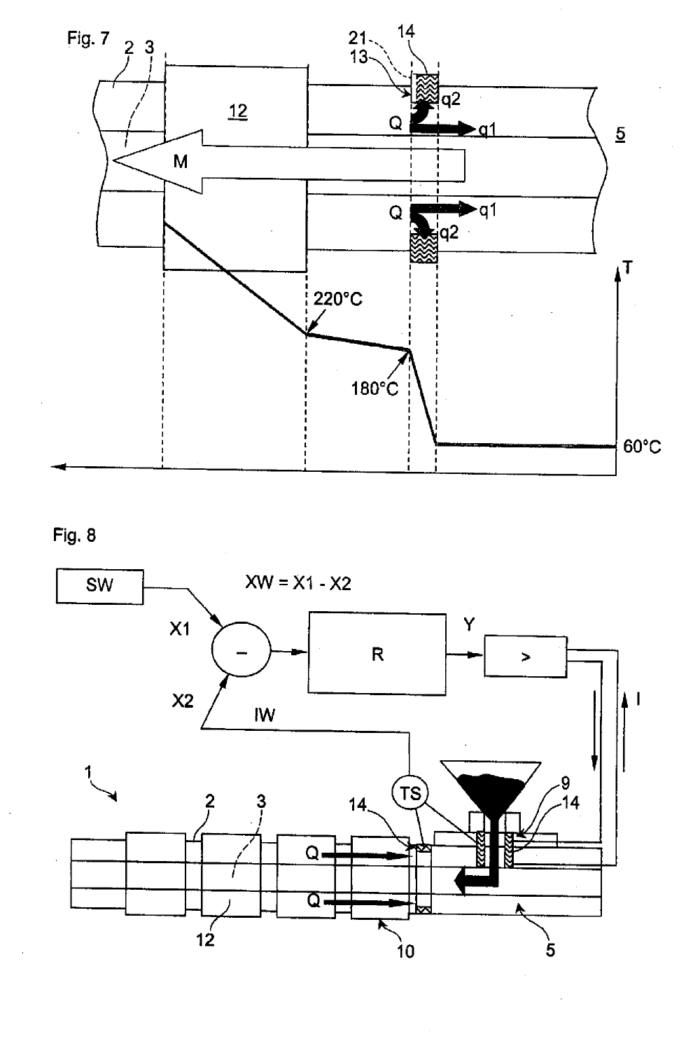

FIG. 7 shows an outlined longitudinal section through a region of the worm cylinder between plasticizing unit and a first heating strip, wherein a basic heat flow is shown in the region of a thermal separation groove in conjunction with an associated heat development diagram; and

FIG. 8 shows a circuit diagram of a control circuit of a worm extruder comprising an active heat barrier on a feed throat according to FIG. 5 and in a thermal separation groove according to FIG. 7.

Parts, functional groups or components, and process steps which are alike in the various illustrations and embodiments are hereinafter denoted by like reference numerals and designations.

FIG. 1 shows a schematic sectional illustration of a basic design of a worm extruder 1 comprising a worm cylinder 2 and a worm shaft 3 which is arranged therein so as to be drivable for rotation by a drive which is not described any further. In an end region, which is referred to as plasticizing unit 5, the worm cylinder 2 comprises an inlet opening 6 for feeding a plastic material or mixtures of several plastic materials and/or additives, which are in the form of a bulk material 7, into a feed zone via a feed throat 9. While being conveyed from the feed zone to a transformation zone 10, the bulk material 7 is compressed and heated up at the same time. To this end, electric heating strips 12 are arranged on the worm cylinder 2 in the region of the transformation zone which introduce heat into a material flow M via the worm cylinder 2. This, however, also leads to the development of a heat flow Q which is directed towards the plasticizing unit 5 where it may result in a temperature increase which is sufficient to cause partial melting of the bulk material 7 that is supplied with a defined grain size. This may cause individual grains to clump together in such a way that the region of the inlet opening 6 may even become clogged; in any case, there will be cycle time variations due to a more irregular feed of material, and therefore considerable parameter deviations in the end product which is supplied to a subsequent tool.

Various measures are known from prior art in order to reduce such deteriorations in quality of the material flow M at an outlet of the worm extruder 1. The unwanted heat conduction is reduced by means of a so-called heat-conduction interrupting groove 13 which is provided at the transition between a last heating strip 12 of the transformation zone 10. This heat-conduction interrupting groove 13 is also referred to as heat insulation groove or thermal separation groove 13. Said groove 13, which is in the shape of a groove or material reduction that is closed along the periphery, reduces the amount of material that is available for heat conduction.

Furthermore, it is already known from prior art to arrange at least one cooling device K in a section of the worm extruder 1 adjoining the inlet opening 6. As shown in FIG. 2 which indicates the heat flows Q, the cooling device K is a water cooling system with a cold-water inlet k and a hot-water outlet w, thus serving as a counterflow heat exchanger. Additionally required expenditures for corrosion protection and sealing of the remaining elements which are operated at high current intensities are known to those skilled in the art, and are therefore only indicated by the fact that they require large amounts of water to ensure sufficient cooling.

In contrast to prior-art devices, the basic design of which is shown in FIG. 2, a region of the feed throat 9 of the inventive embodiment according to FIG. 1 is provided with an active heat barrier 14.

A heat barrier 14 of this type comprises electrically active components in the form of so-called Peltier elements 16. These elements 16 provide a cooling effect already in the region of the feed throat 9, thus ensuring an effective dissipation of heat which is generated when material is conveyed so as to prevent the bulk material 7 from clumping together.

FIG. 3 shows an outlined longitudinal section through an embodiment of a feed throat 9 comprising an active heat barrier 14 which is in the shape of a sleeve and which is provided with a insulating layer 17 of good heat conductivity on a cylinder inside and with a heat-insulating layer 18 on a cylinder outside. The use of Peltier elements 16 as electrically controllable means for heat dissipation is known, wherein a respective dissipable heat flow q2 is controllable via a flow of current I through the respective Peltier element 16. They are designed as flat or bent components which are, in this embodiment, brought into thermal contact with the conducting layer 17 for dissipation of a heat flow q2. The arrangement is enclosed towards the outside by the heat-insulating layer 18. As a result, the heat flow Q is partially prevented from flowing into the bulk material 7. In addition, a passive cooling effect is achieved by way of the conducting layer 17 which is joined to the convective cooling body 19. A resulting temperature drop is outlined in FIG. 4; by means of active and passive measures, a maximum temperature of approx. 240° C. is reduced to a temperature of approx. 60° C. in the region of the bulk material 7. A first considerable temperature reduction is achieved by means of the insulating layer 18. Another temperature reduction is achieved by the combined effects of the conducting layer 17 and the Peltier elements 16. This embodiment requires a relatively small amount of energy in order to guarantee a desired temperature.

A variation of the embodiments according to FIGS. 3 and 4 is illustrated in FIG. 5 which again shows an outlined longitudinal section through another embodiment. In this embodiment, commercially available types of Peltier elements 16 are used in a modified version of a feed throat of a plasticizing unit comprising an active heat barrier 14, a heat insulation 18 and a layer 17 of good heat conductivity. In the region of the worm cylinder 2 is arranged a heat-insulating sleeve which consists of ceramic material in this embodiment. In the direction of the actual feed throat 9 is arranged the heat-conducting layer 17 which extends beyond the wall thickness of the worm cylinder 2. Conventional plate-shaped Peltier elements 16 are arranged outside the worm cylinder 2 as individual modules which are connected with cooling bodies 19 to guarantee a heat dissipation. FIG. 6 shows a corresponding plan view of the feed throat 9 of the embodiment according to FIG. 5.

FIG. 7 shows an outlined longitudinal section through a region of the worm cylinder 2 between plasticizing unit 5 and first heating strip 12, a basic heat flow being shown in the region of the thermal separation groove 13 in conjunction with an associated temperature development diagram. According to this diagram, the worm cylinder 2 has a temperature of approximately 220° C. behind the heating strip 12 which is reduced to approx. 180° C. due to heat dissipation to the material flow M and radiation towards the thermal separation groove 13. In the thermal separation groove 13 is arranged an active heat barrier 14 as well. This active heat barrier 14 is in the shape of a ring of Peltier elements 16 through which a partial flow q1 is pumped so that there is only a partial flow q2 left that may be transmitted to the plasticizing unit 5. Consequently, the remaining temperature at the transition between the transformation zone and the feed zone amounts to only approx. 60° C. This embodiment actually requires more electrical energy than the embodiment according to FIG. 2 but has only a minor influence on the surface heating zone when the feed zone temperature changes. Similar to the embodiment according to FIGS. 3 and 5, a heat-insulating layer 21 may additionally be arranged in the groove 13 upstream of the Peltier element 16 in the way as it is outlined in the Figures.

FIG. 8 shows a circuit diagram of a control circuit of a worm extruder 1 with active heat barriers 14 at a feed throat 9 according to FIG. 5 and in a thermal separation groove 13 according to FIG. 7. Both active heat barriers 14 are monitored by means of a temperature sensor TS which produces an output quantity, in other words an actual value IW, which is compared to the quantity XL of a desired value SW. A control deviation XW=X1−X2 is transmitted to a controller which emits a control signal y that is transmitted—in the form of electric current—to one or both active heat barriers 14 by means of an amplifier.

Advantageously, none of the above described embodiments of the invention requires cooling water in the region of the plasticizing unit 5. Consequently, a short circuit at the heating strips due to leaking water is avoided at least in this region. Moreover, an above described cooling system of a feed zone is completely independent of a local water pressure, which is of particular importance for Asian countries. Likewise, as this prevents condensed water from settling on the plasticizing unit, the machine is therefore not prone to rusting. Compared to known installations, a much smaller number of hose lines are required. When installing an inventive worm extruder instead of conventional devices, this may yield even higher savings since cooling plates, valves blocks and pipings are no longer required and are replaced by cheaper Peltier coolers comprising corresponding cooling bodies, heat-conducting surfaces and insulations as well as a circuit amplifier.

### LIST OF REFERENCE NUMERALS

1 worm extruder
2 worm cylinder
3 worm shaft
5 plasticizing unit
6 inlet opening
7 bulk material
9 feed throat
10 transformation zone
12 heating strip
13 thermal separation groove
14 active heat barrier
16 Peltier element
17 layer of good heat conductivity
18 heat-insulating layer
19 cooling body for free convection of heat
21 heat-insulating layer
M material flow
Q heat flow
k cold-water inlet
w hot-water outlet
q1 partial heat flow
q2 partial heat flow
SW desired value
IW actual value
X1 quantity of the desired value
X2 quantity of the actual value
XW control deviation
R controller
TS temperature sensor
I electric current

1.-10. (canceled)

11. A worm extruder, comprising:
a worm cylinder having an inlet opening in an end region for feeding plastic material or a mixture of plastic materials and/or additives in the form of a bulk material via a feed throat;
a worm shaft received in the worm cylinder for rotation therein;
at least one cooling device provided in a section of the worm cylinder adjoining the inlet opening; and
an active heat barrier provided in a region of the feed throat and including electrically controllable means for heat dissipation, wherein the heat barrier includes a heat insulation.

12. The worm extruder of claim 11, wherein the heat insulation is formed in the shape of a sleeve on an outside of the heat barrier.

13. The worm extruder of claim 11, wherein the heat insulation is a ceramic element.

14. The worm extruder of claim 11, wherein the heat barrier includes at least one Peltier element.

15. The worm extruder of claim 11, wherein the heat barrier has a layer of heat conductivity towards a wall of the feed throat.

16. The worm extruder of claim 11, wherein the heat insulation is cylindrical and has on its inside a heat conductive layer.

17. The worm extruder of claim 15, wherein the layer is made of a material selected from the group consisting of copper and evacuated stainless steel.

18. The worm extruder of claim 11, wherein the active heat barrier is received in a thermal separation groove.

19. The worm extruder of claim 11, wherein the active heat barrier includes a heat insulation on at least one side facing a heat flow during operation.

20. The worm extruder of claim 11, wherein the active heat barrier has two longitudinal sides, with a heat insulation being provided on each of the two longitudinal sides.

21. The worm extruder of claim 11, wherein cooling sheets or cooling bodies are arranged on a free, outwardly oriented surface of the active heat barrier in order to improve at least a convective heat transmission.
